(19) United States
(12) Patent Application Publication
(10) Pub. No.: US 2015/0161801 A1
(43) Pub. Date: Jun. 11, 2015

(54) CALIBRATION SYSTEMS AND METHODS FOR SENSOR PAYLOADS

(71) Applicant: ISRAEL AEROSPACE INDUSTRIES LTD., Lod (IL)

(72) Inventors: Roni Schwartz, Kfar Saba (IL); Nadav Raichman, Kibbutz Yakum (IL); Roy Bubis, Petach Tiqwa (IL)

(21) Appl. No.: 14/413,219

(22) PCT Filed: Apr. 2, 2013
(86) PCT No.: PCT/IL2013/050299

§ 371 Date: Jan. 6, 2015

(30) Foreign Application Priority Data
Jul. 8, 2012 (IL) 220815

(51) Int. Cl. G06T 7/20; G06T 7/00; G06T 7/60

(52) U.S. Cl. CPC G06T 7/2093; G06T 7/606; G06T 7/003; G06T 2207/10048; G06T 2207/10036; G06T 2207/20216; G06T 2207/30181

(57) ABSTRACT

The present disclosure provides notably a calibration system suitable for in-flight calibration of a sensor payload. The calibration system comprises an emitting object being configured for emitting in a first emitting spectral band and in a second emitting spectral band a predetermined pattern comprising a plurality of lighted areas on a homogeneous background; and a collimation optical unit configured for setting the emitting object at infinity.

### TECHNOLOGICAL FIELD

This invention relates generally to sensor payloads. Particularly, the invention relates to systems and methods for improving calibration of a payload including a plurality of imaging sensors.

### BACKGROUND

Sensor payloads are generally mounted on vehicles such as aircrafts, ships or ground vehicles. Payloads can be provided with several imaging sensors to collect data on a scene observed, for example through different spectral bands. In some applications, it may be useful to perform a fusion of the images acquired by two or more sensors. In the case of two sensors for example, image fusion generally consists of superposing the two images so that a user may more efficiently apprehend the data collected by the two sensors. Image fusion may preliminary require a step of registration in which a mapping between the two images may be determined so as to compensate for the sensors' misalignment, tilt, field of view difference, etc. Various techniques currently exist for registering images acquired through two or more sensors. In some techniques, the registration of images acquired by several imaging sensors configured to observe the same scene may be based on determining a linear transformation, including rotation, translation and scaling to relate the images acquired by the two sensors. However, in operation situations, because of material dilatation caused by temperature variations, linear transformation may have to be frequently recalculated so as to compensate for the relative displacements of the sensors. FIG. 1 illustrates a standard configuration of an aircraft vehicle 1 mounted with a payload system 2 including two cameras monitoring a ground surface 3. As can be seen on FIG. 1, the two cameras have different fields of view and the registration of images from these two cameras would therefore require determining a magnification ratio between the images of the two cameras. Additionally, even though a relative position of the two cameras may be evaluated during manufacture, the exact positioning may have to be regularly calibrated.

Some techniques for determining linear transformation for image registration involve a periodical comparison of images of a ground surface scene acquired by the two sensors on a pixel by pixel basis in order to determine an exact mapping from one image to the other. However, these techniques are not well adapted for cameras having different fields of view. Some other techniques, as disclosed for example in U.S. Pat. No. 5,274,236, are also based on comparison of images of a ground surface scene but further involve “hot spots” determination in the two images and a comparison limited to the hot spots of the two images so as to determine the best mapping from the hot spot coordinates of one image to the hot spot coordinates of the other. However, all these techniques require heavy image processing and are therefore complicated to implement, especially in situations in which the overall size and weight is limited, such as in unmanned vehicle control equipment.

### General Description

In a first broad aspect, the present disclosure provides a calibration system suitable for in-flight calibration of a sensor payload. The calibration system comprises an emitting object being configured for emitting in a first emitting spectral band and in a second emitting spectral band a predetermined pattern comprising a plurality of lighted areas on a homogeneous background; and a collimation optical unit configured for setting the emitting object at infinity. The calibration system may have dimensions suitable for being mounted on a vehicle and preferably for being mounted in a payload system. The pattern emitted is particularly adapted for image registration and therefore requires a lesser amount of processing.

In some embodiments, the lighted areas are substantially of the same intensity within said first and second emitting spectral bands.

In some embodiments, the homogeneous background is substantially black within said first and second emitting spectral bands.

In some embodiments, at least some of the lighted areas have a circular shape and/or a simple polygonal shape.

In some embodiments, the pattern consists of the plurality of lighted areas on the homogeneous pattern.

In some embodiments, the plurality of lighted areas consists of four circles.

In some embodiments, the first and second emitting spectral bands respectively belong to an infrared spectral band and a visible spectral band.

In some embodiments, the calibration system further comprises a distribution optical unit configured for splitting a beam output by the collimation optical unit into two calibration beams.

In a second broad aspect, the present disclosure provides a payload system. The payload system comprises a first imaging sensor sensitive in a first receiving spectral band; a second imaging sensor sensitive in a second receiving spectral band; a calibration system according to any of the preceding claims, wherein the emitting spectral bands are overlapping the receiving spectral bands. The calibration system and the first and second imaging sensors are relatively configured so as to enable optical alignment between said first and second imaging sensors and said calibration system thereby allowing simultaneous imaging of the emitting object through the optical collimation unit. The payload system provides a built-in configuration allowing calibration on demand of both sensors and periodical check-up of the sensors calibration.

In some embodiments, the calibration system is movable within the payload system enabling the imaging sensors to simultaneously image the emitting object through the optical collimation unit.

In some embodiments, the first and second imaging sensors are movable within the payload system enabling the sensors to simultaneously image the emitting object through the optical collimation unit.

In some embodiments, the payload system further comprises a retractile mirror system enabling the optical alignment of the first and second sensors with the calibration system.

In some embodiments, the first and second imaging sensors are respectively sensitive in infrared and visible spectral bands.

In some embodiments, the first and second imaging sensors are coupled so that a movement of an optical axis of the first imaging sensor is substantially identical to a movement of an optical axis of the second imaging sensor.

In some embodiments, the pattern is configured so that a signal to noise ratio of the lighted areas with regard to the background is superior to 10.

In some embodiments, the payload system further comprises a laser designator.

In another broad aspect, the present disclosure provides a method of determining registration parameters between two imaging sensors of a sensor payload mounted on an aircraft. The method comprises providing onboard an emitting object configured for being detected by the two imaging sensors, the emitting object emitting a pattern suitable for image registration; acquiring simultaneously a calibration image of the emitting object through an optical collimation unit with each imaging sensor; and determining registration parameters between the two imaging sensors by analyzing the calibration images. The pattern suitable for image registration may refer to a pattern as previously described with reference to the calibration system.

In some embodiments, the pattern comprises lighted areas on a homogeneous background, the lighted areas having a high contrast.

In some embodiments, the two imaging sensors are respectively sensitive in an infrared spectral band and in a visible spectral band and the emitting object is emitting in both the infrared and the visible spectral bands.

In some embodiments, determining registration parameters comprises determining the center of the emitted pattern on each calibration image, a calibration rotation angle around a central axis perpendicular to one of the calibration images for coinciding a reference direction of the emitted pattern in said calibration image with the reference direction of the emitted pattern in the other calibration image and a ratio of magnification between the calibration images.

In some embodiments, determining the ratio of magnification comprises: determining the position of the gravity centers of at least two lighted areas for each calibration image; calculating the distance between said gravity centers in each calibration image; and evaluating a ratio between said distances in the two calibration images.

In some embodiments, determining the calibration rotation angle comprises determining the position of the gravity centers of at least two lighted areas for each calibration image; and evaluating an angle between a segment joining the at least two gravity centers in one calibration image and a segment joining said gravity centers in the other calibration image.

In another aspect the present disclosure provides a method of fusion of images acquired by two imaging sensors of a sensor payload mounted on an aircraft. The method comprises: determining registration parameters between the two imaging sensors according to the method of determining registration parameters previously described; and performing fusion of the images acquired by the two imaging sensors using said registration parameters.

In another aspect, the present disclosure provides a method of boresighting a laser designator with respect to a first and a second imaging sensor of a sensor payload mounted on an aircraft. The method comprises determining a position of the laser designator in images acquired by the first imaging sensor; determining registration parameters between the two imaging sensors according to the method previously described; and determining a position of the laser designator in images acquired by the second imaging sensor based on the position of the laser designator in images acquired by the first imaging sensor and on the registration parameters between the two imaging sensors.

In some embodiments, determining the position of the laser designator in images acquired by the first imaging sensor is performed by line of sight boresighting.

In some embodiments, the first imaging sensor is sensitive to a wavelength of the laser designator so that determining the position of the laser designator in images acquired by the first imaging sensor can be performed by determining the position of a spot corresponding to the laser designator on the images acquired by the first imaging sensor.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1, previously described, illustrates a payload including two cameras embedded on an aircraft.

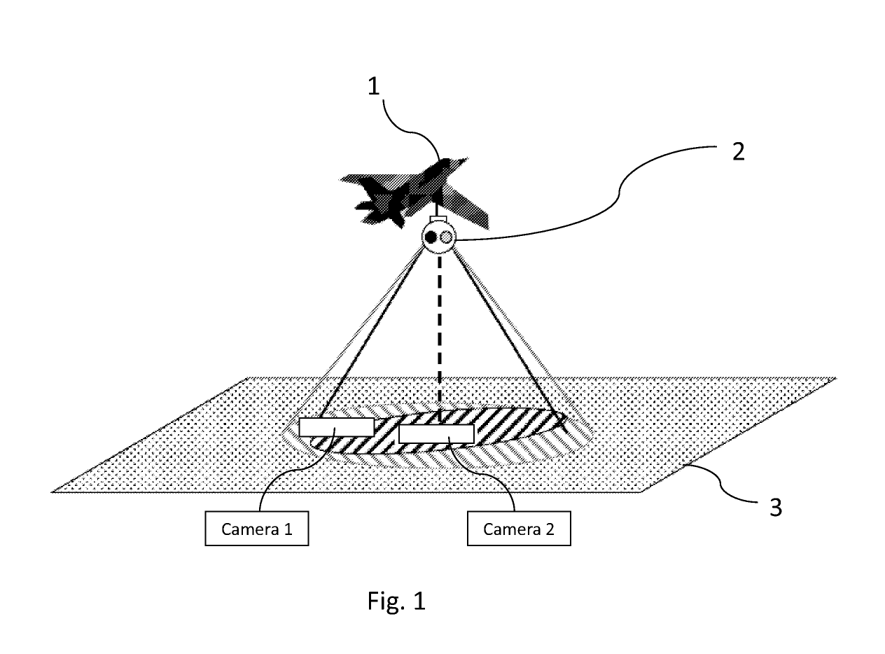

FIGS. 2A-2B illustrate payload systems according to two variants of the present disclosure.

FIG. 3 is a block diagram illustrating general steps of a method of fusion of images acquired by two or more sensors of a payload according to some embodiments of the present disclosure.

FIGS. 4A-4B illustrate calibration images of the calibration system acquired by two sensors of a payload system according to an embodiment of the present disclosure.

FIG. 5A-5B illustrate steps of a method for determining registration parameters from calibration images according to an embodiment of the present disclosure; and

FIG. 6 illustrates a payload system according to an embodiment of the present disclosure.

### DETAILED DESCRIPTION OF EMBODIMENTS

Described herein are some examples of systems and methods for improving calibration of a payload system including two or more imaging sensors.

In the following, it is to be understood that the term “calibration” at least refers to the registration of images from two or more sensors, for example by determining a linear transformation between said images. Further, the term “suitable for in-flight calibration” may comprise the features that the calibration system has attachment means for enabling attachment to a payload system, and/or that the calibration system faces size constraints so that the calibration system may be compact and may fit into a payload system intended to be mounted to a vehicle, and/or that the calibration faces material constraints so that the calibration system may be configured to resist to temperature variations, accelerations, etc.

In the following detailed description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail so as not to obscure the description.

As used herein, the phrase “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “generating”, “determining”, “providing”, “receiving”, “using”, “coding”, “handling”, “compressing”, “spreading”, “transmitting”, “amplifying”, “performing”, “forming”, “analyzing”, “or the like, refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

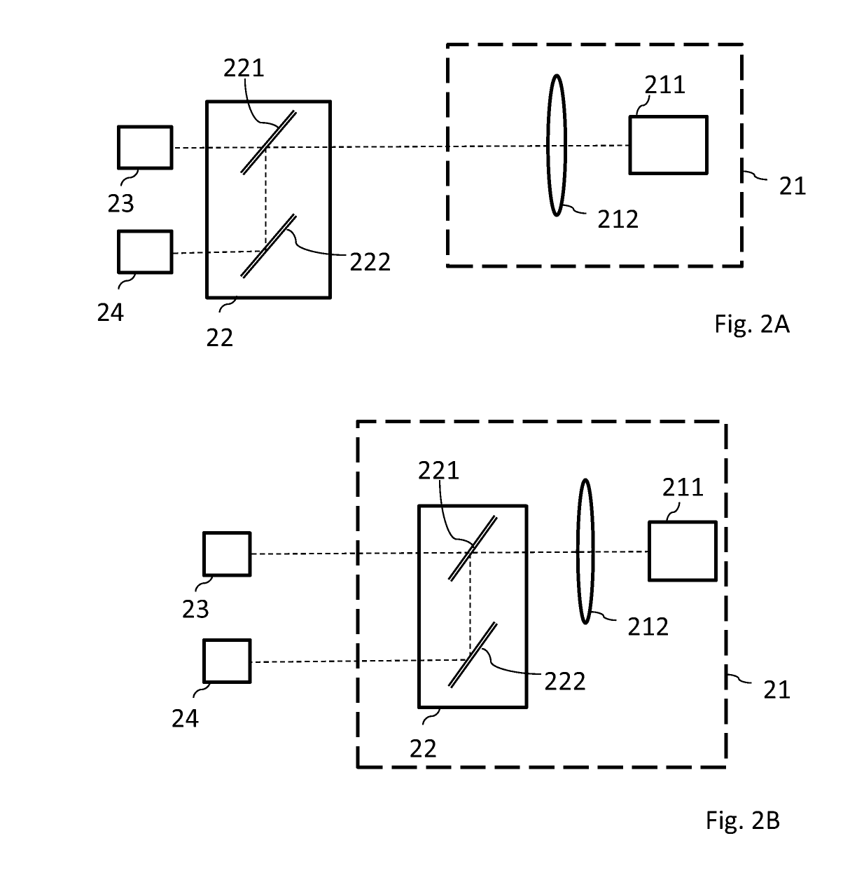

FIGS. 2A and 2B illustrate two variants of a payload system according to some embodiments of the present disclosure. In both variants, the payload system comprises a calibration system 21, a distribution unit 22, a first imaging sensor 23 and a second imaging second sensor 24. Since the two variants only differ in the feature that the distribution unit 22 is positioned either in the calibration system 21 or in the vicinity of the sensors 23, 24, they are described together for the sake of conciseness.

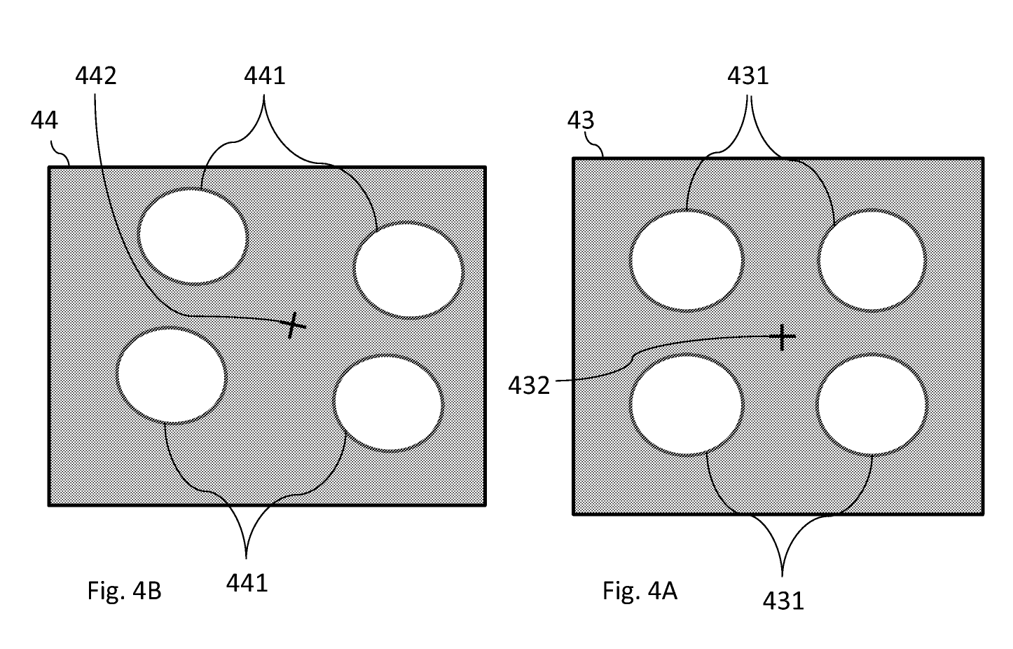

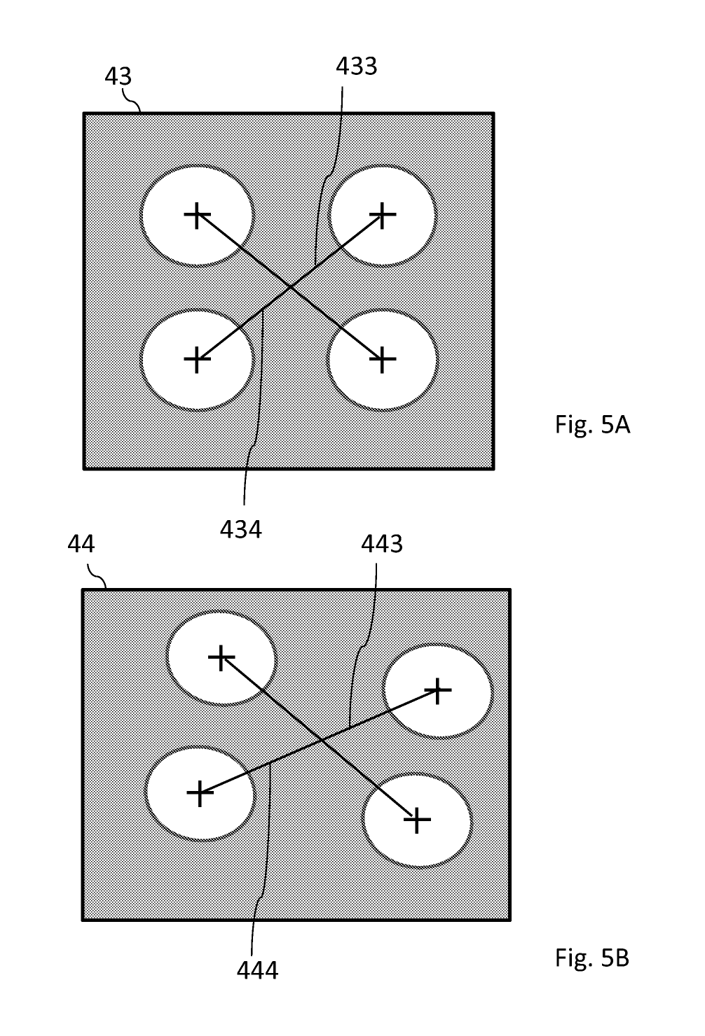

The calibration system 21 may comprise an emitting object 211 and a collimation unit 212. The emitting object 211 may be configured for emitting a predetermined pattern comprising a plurality of lighted areas on a homogeneous background. The emitting object 211 may radiate (emit) in an infrared band and in a visible band. For example, the visible spectral band may be considered to comprise the wavelengths between 0.4 μm and 0.8 μm and the infrared spectral band may comprise either Near IR (NIR) between 0.75 μm and 1.1 μm, Short Wavelength IR (SWIR) between 1.1 μm and 2.5 μm, Mid Wave IR (MWIR) between 3 μm and 5 μm or Long wave IR (LWIR) between 8 μm and 14 μm. For example, the emitting object 211 may comprise a plurality of light emitting diodes arranged on a non emitting support. In another embodiment, the emitting object may comprise a homogeneous source of light collaborating with a diaphragm having a plurality of apertures. In some embodiments, the emitting object 211 may be of passive type i.e. configured for emitting when impinged by a stimulation beam, for example a laser designator of the payload system. In contrast, in some other embodiments, the emitting object 211 may be of active type i.e. configured for emitting continuously when activated electronically or mechanically. The lighted areas may have substantially the same intensity within the visible and infrared spectral bands of interest i.e. all lighted areas being homogeneously intense. The homogeneous background in the pattern emitted by the emitting object 211 may be substantially black within said visible and infrared spectral bands i.e. the level of emission in said spectral bands may be substantially equal to zero for the regions outside the lighted areas. The pattern may be further be defined by a value of a contrast ratio between the intensity emitted by the lighted areas and the background. In some embodiments, the contrast ratio may be superior to 5, 10 or 100. Such a contrast ratio may be measured independently of the sensors 23, 24, for example by an additional sensor sensitive in the same spectral band, and using an electronic oscilloscope to measure the ratio of the voltages of the lighted area and the voltages of the background for several sensor lines. The pattern may also be defined by using a signal to noise ratio between the lighted areas and the background as provided by one or more sensors of the payload system. Such signal to noise ratio may be given by a ratio between the average value of the signal measured by one of the sensors (or an average value of the signals measured by several sensors) for one or more lighted areas and the average value of the noise measured by said one sensor (or an average value of the noise measured by said several sensors) for said one or more lighted areas. The emitting object 211 may be configured so that the pattern has a signal to noise ratio superior to 5, 10 or 100. In some embodiments, as described later with reference to FIGS. 4 and 5, the lighted areas may have a circular shape and/or simple polygonal shape. For example, the pattern may consist of four circular lighted areas.

The collimation optical unit 212 may be configured to set the emitting object 212 at infinity. For example, the collimation optical unit 212 may comprise a converging optical element and the emitting object 211 may be positioned at a focal point of said optical element.

The distribution unit 22 may be positioned downstream of the collimation optical unit 212 and configured to split a beam incident on the distribution unit 22 into two separate beams (calibration beams). Additionally, in some embodiments the distribution unit 22 may be configured so that the two separate beams are spectrally separated. In order to spectrally separate the incident beam, the distribution unit 22 may comprise a dichroïc mirror 221 and standard mirror 222 arranged in parallel to enable both spectral and physical separation of the incident beam. The distribution unit 22 therefore enables the first and second sensor 23, 24 to image simultaneously the emitting object 211 through the collimation optical unit 212. As previously explained and illustrated in FIGS. 2A-2B, the distribution unit 22 may be arranged in the calibration system 21 or be arranged in the vicinity of the imaging sensors 23, 24, for example within a common objective of the sensors.

The first and second imaging sensors 23, 24 may be respectively sensitive in a first infrared spectral band and in a second visible spectral band. For example, the first and second imaging sensors 23, 24 may be an InSb sensor for the infrared spectral band and CCD sensor for the visible spectral band. In some embodiments, the calibration system 21 may also be used in a payload system having two imaging sensors sensitive in the same spectral band as long as the emitting object 211 emits in said spectral band, and the distribution unit 22 provides to both sensors, light within said spectral band.

The calibration system 21 provides a pattern suitable for image registration which lowers image processing calculation required to determine a linear transformation relating the images of the first and second sensors 23, 24 with regard to using an image of a background scene for image registration. The calibration system 21 and the first and second sensors 23, 24 may be configured so that said sensors are capable of simultaneously imaging the emitting object 211 through the collimation optical unit 212. For example, the sensors 23, 24 may be mounted on a movable plate (not shown) that can be moved upon request or periodically within the payload system so that the sensors 23, 24 are placed in front of the calibration system. In another example, the calibration system 21 may be mounted on a movable plate that can be moved upon request or periodically within the payload system so that the calibration system 21 is placed in front of the sensors 23, 24. It is to be understood that the term “in front” used hereinabove refers to an optical alignment and may also involve the use of additional optical elements such as movable mirrors. Optically aligning periodically or upon request the calibration system 21 and the sensors 23, 24 enables frequent and easy calculation of a linear transformation relating the images acquired by the first and second sensors 23, 24 thereby correcting relative displacements of the first and second sensors 23, 24.

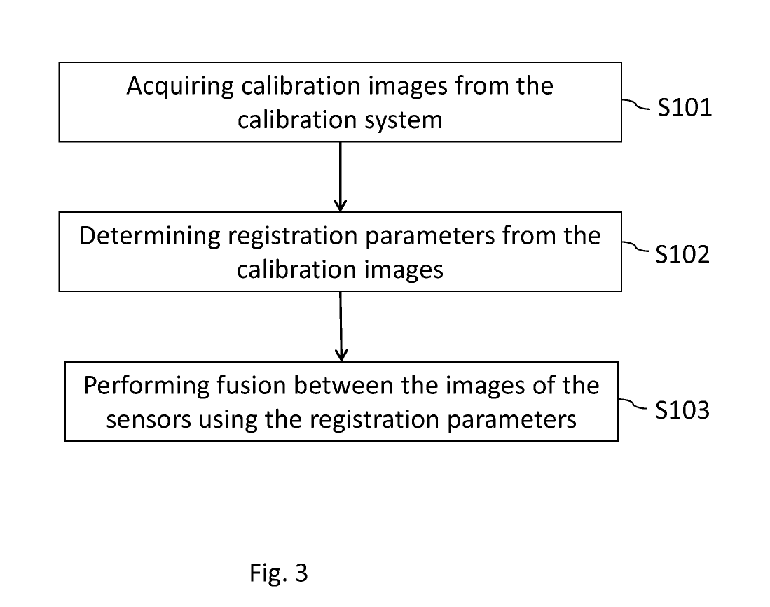

FIG. 3 illustrates schematically some steps of a method for fusion of images acquired in-flight by a plurality of sensors of a payload system mounted on an aircraft vehicle according to some embodiments of the present disclosure. In the following, the payload system is considered to include a calibration system as previously described. In a first step S101, calibration images of the emitting object may be acquired by the first and second sensors through the collimation optical unit of the calibration system. The calibration images are images of the emitting object acquired by the first and second sensors. Step S101 may comprise moving the calibration system so as to optically align the emitting object with the two sensors using the distribution unit. In a second step S102, the calibration images acquired are analyzed in order to determine registration parameters i.e. a linear transformation relating the calibration image from one sensor to the calibration image from the other sensor thereby enabling to relate the images acquired thereafter by the first and second sensors. Step S102 may include determining the center of the emitted pattern on each calibration image so as to derive a translation component of the linear transformation. Step S102 may further include determining a calibration rotation angle around a central axis perpendicular to one of the calibration images for coinciding a reference direction of the emitted pattern in said calibration image with the reference direction of the emitted pattern in the other calibration image so as to determine a rotation component of the linear transformation. Step S102 may also include determining a ratio of magnification between the calibration images so as to determine a scaling component of the linear transformation. Details as to the determination of the translation, rotation and scaling components are described below for an example of an emitted pattern with reference to FIGS. 4 and 5. In a third step S103, the fusion of images acquired by the first and second sensors may be performed, given the linear transformation determined in step S102.

FIGS. 4A-4B illustrate calibration images acquired by sensors of a payload system as previously described, in which the pattern emitted by the emitting object consists of four circular lighted areas. FIGS. 5A-5B illustrate steps of a method of determining registration parameters between the calibration images presented in FIGS. 4A-4B. A first calibration image 43 and a second calibration image 44 acquired respectively by the first and second sensors of the payload system are respectively presented in FIGS. 4A and 4B. The images of the lighted areas of the pattern in the first and second calibration images 43, 44 are respectively referenced 431 and 441. The center of the emitted pattern in the first and second calibration images 43, 44 i.e. the image of the geometrical center of the pattern in the first and second calibration images 43, 44, are respectively referenced 432 and 442. A difference in the coordinates of the center of the emitted pattern 432 and 442 may enable to determine a translation component of a linear transformation relating to the first and second calibration images.

With reference to FIGS. 5A and 5B, the determination of a rotation component of the linear transformation may include determining the position of the gravity centers of the images of the lighted areas in the calibration images 43 and 44 (the gravity centers of the images of the lighted areas in the calibration images are also referred to as the gravity centers of the lighted areas). In FIGS. 5A and 5B, the gravity centers of the lighted areas are simply marked by a cross inside the lighted areas. A first reference direction of the emitted pattern may be defined by a first segment joining two gravity centers of two predetermined lighted areas. In FIGS. 5A and 5B, the images of the first segment in the first and second calibration images are respectively referenced under reference 433 and 443 and join the images of the gravity centers of said two predetermined lighted areas. In one embodiment, a rotation component of the linear transformation relating the first and second calibration images may be determined by calculating an angle formed by the images of the first segment 433 and 443 in the first and second calibration images 43, 44. A second reference direction of the emitted pattern may be defined by a second segment joining two other predetermined lighted areas in the emitted pattern. In FIGS. 5A and 5B, the images in the first and second calibration images of the second segment are respectively referenced under reference 434 and 444 and join the gravity centers of said two others predetermined lighted areas. In an embodiment, the rotation component of the linear transformation may be determined as an average between the angle formed by the images 433, 443 of the first segment in the first and second calibration images 43, 44 and the angle formed by the images 434, 444 of the second segment in the first and second calibration images 43, 44.

The determination of the scaling component of the linear transformation i.e. a ratio of magnification between the calibration images, may be obtained by calculating a ratio of the lengths of the images 433, 443 of the first segment in the first and second calibration images 43, 44. In another embodiment, the ratio of magnification can be obtained as an average between the ratio of the lengths of the images 433, 443 of the first segment in the first and second calibration images 43, 44 and the ratio of the lengths of the images 434, 444 of the second segment in the first and second calibration images 43, 44. Further, it is to be noted that the determination of the linear transformation may also require knowing with precision the intrinsic parameters of the imaging sensors and relative parameters regarding the relative position of said imaging sensors.

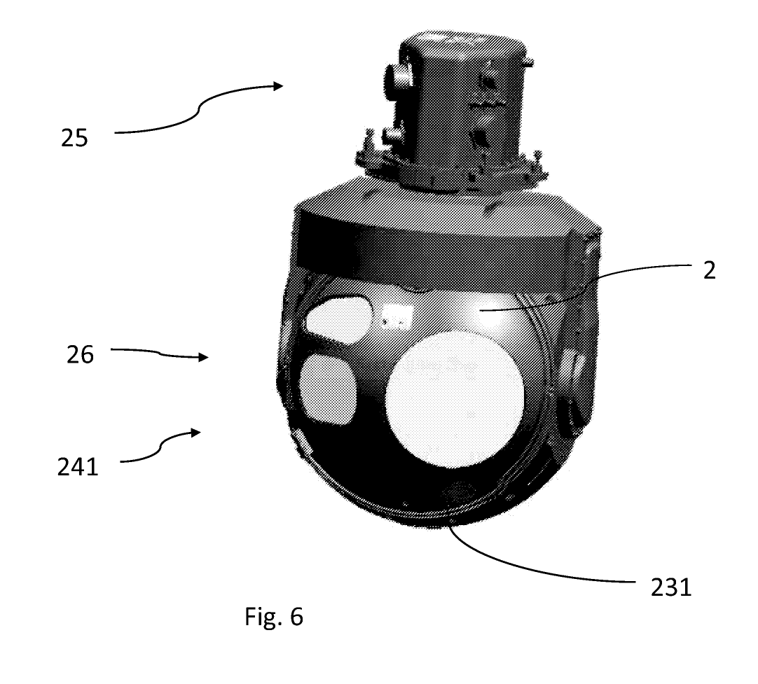

FIG. 6 illustrates a payload system 2 according to some embodiments of the present disclosure. The payload system 2 notably includes an attachment mechanism 25 configured for mounting the payload system 2 on an aircraft vehicle and first and second sensor optics 231 and 241 respectively associated with the first and second sensors for directing light onto said sensors. The payload system 2 further includes a laser designator unit 26. In some embodiments, boresighting of the laser designator with respect to one of the image sensors may be derived from boresighting of the laser designator with respect to the other imaging sensor and from the registration parameters of said sensor with regard to the other. The boresight procedure (also referred to as boresighting) may comprise identifying a pixel in an image acquired by an imaging sensor that corresponds to the centre of the laser spot of the laser designator on a distant target (scene). The boresighting of the laser designator with respect to a predetermined imaging sensor may be performed by line of sight boresighting. Line of sight boresighting may comprise designating a target with the laser and finding the sub-pixel coordinates on the imaging sensor that corresponds to the center of the laser spot. In other embodiments, boresighting of a laser designator with respect to an imaging sensor may also be performed by having the imaging sensor sensitive to the wavelength of the laser designator so that the imaging sensor is able to image directly the spot. This kind of imaging sensor is commonly called a “see spot” camera.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A payload system comprising:
a first imaging sensor sensitive in a first receiving spectral band;
a second imaging sensor sensitive in a second receiving spectral band;
a calibration system suitable for in-flight calibration of the sensor payload system comprising:
an emitting object being configured for emitting in a first emitting spectral band and in a second emitting spectral band a predetermined pattern comprising a plurality of lighted areas on a homogeneous background; and
a collimation optical unit configured forsetting the emitting object at infinity;
wherein the emitting spectral bands are overlapping the receiving spectral bands and the first and second imaging sensors or the calibration system are relatively configured movable within the payload system so as to enable, upon request or periodically, optical alignment between said first and second imaging sensors and said calibration system thereby allowing simultaneous imaging of the emitting object through the optical collimation unit; and
wherein the payload system is further configured to calculate a linear transformation relating images acquired by the first and second imaging sensors for correcting relative displacements of the first and second sensors, thereby determining the registration parameters between the first and second imaging sensors.

2. The payload system according to claim 1, wherein the lighted areas are substantially of the same intensity within said first and second emitting spectral bands.

3. The payload system according to claim 1, wherein the homogeneous background is substantially black within said first and second emitting spectral bands.

4. The payload system according to claim 1, wherein at least some of the lighted areas have a circular shape and/or a simple polygonal shape.

5. The payload system according to claim 1, wherein the pattern consists of the plurality of lighted areas on the homogeneous pattern.

6. The payload system according to claim 1, wherein the plurality of lighted areas consists of four circles.

7. The payload system according to claim 1, wherein the first and second emitting spectral bands respectively belong to an infrared spectral band and a visible spectral band.

8. The payload system according to claim 1, further comprising a distribution optical unit configured for splitting a beam output by the collimation optical unit into two calibration beams.

9. The payload system of claim 1, further comprising a retractile mirror system enabling the optical alignment of the first and second sensors with the calibration system.

10. The payload system according to claim 1, wherein the first and second imaging sensors are respectively sensitive in infrared and visible spectral bands.

11. The payload system according to claim 1, wherein the first and second imaging sensors are coupled so that a movement of an optical axis of the first imaging sensor is substantially identical to a movement of an optical axis of the second imaging sensor.

12. The payload system according to claim 1, wherein the pattern is configured so that a signal to noise ratio of the lighted areas with regard to the background is superior to 10.

13. The payload according to any of claim 1, further comprising a laser designator.

14. A method of determining registration parameters between two imaging sensors of a sensor payload mounted on an aircraft, the method comprising:
providing onboard an emitting object configured for being detected by the two imaging sensors, the emitting object emitting a pattern suitable for image registration, the emitting object or the two imaging sensors being further configured to be movable within the sensor payload so as to enable, upon request or periodically, optical alignment between said first and second imaging sensors and said emitting object;
acquiring simultaneously a calibration image of the emitting object through an optical collimation unit with each imaging sensor; and
determining registration parameters between the two imaging sensors by analyzing the calibration images.

15. The method according to claim 14, wherein the pattern comprises lighted areas on a homogeneous background, the lighted areas having a high contrast.

16. The method according to claim 14, wherein the two imaging sensors are respectively sensitive in an infrared spectral band and in a visible spectral band and the emitting object is emitting in both the infrared and the visible spectral bands.

17. The method according to claim 14, wherein determining registration parameters comprises determining the center of the emitted pattern on each calibration image, a calibration rotation angle around a central axis perpendicular to one of the calibration images for coinciding a reference direction of the emitted pattern in said calibration image with the reference direction of the emitted pattern in the other calibration image and a ratio of magnification between the calibration images.

18. The method according to claim 17, wherein determining the ratio of magnification comprises:
determining the position of the gravity centers of at least two lighted areas for each calibration image;
calculating the distance between said gravity centers in each calibration image; and
evaluating a ratio between said distances in the two calibration images.

19. The method according to claim 17, wherein determining the calibration rotation angle comprises:
determining the position of the gravity centers of at least two lighted areas for each calibration image; and
evaluating an angle between a segment joining the at least two gravity centers in one calibration image and a segment joining said gravity centers in the other calibration image.

20. A method of fusion of images acquired by two imaging sensors of a sensor payload mounted on an aircraft, the method comprising:
determining registration parameters between the two imaging sensors by
i. providing onboard an emitting object configured for being detected by the two imaging sensors, the emitting object emitting a pattern suitable for image registration, the emitting object or the two imaging sensors being further configured to be movable within the sensor payload so as to enable, upon request or periodically, optical alignment between said first and second imaging sensors and said emitting objects;
ii. acquiring simultaneously a calibration image of the emitting object through an optical collimation unit with each imaging sensor; and
iii. determining registration parameters between the two imaging sensors by analyzing the calibration image; and
performing fusion of the images acquired by the two imaging sensors using said registration parameters.

21. A method of boresighting a laser designator with respect to a first and a second imaging sensor of a sensor payload mounted on an aircraft, the method comprising:
determining a position of the laser designator in images acquired by the first imaging sensor;
determining registration parameters between the two imaging sensors by:
i. providing onboard an emitting object configured for being detected by the two imaging sensors, the emitting object emitting a pattern suitable for image registration, the emitting object or the two imaging sensors being further configured to be movable within the sensor payload so as to enable, upon request or periodically, optical alignment between said first and second imaging sensors and said emitting objects;
ii. acquiring simultaneously a calibration image of the emitting object through an optical collimation unit with each imaging sensor; and
iii. determining registration parameters between the two imaging sensors by analyzing the calibration image; and
determining a position of the laser designator in images acquired by the second imaging sensor based on the position of the laser designator in images acquired by the first imaging sensor and on the registration parameters between the two imaging sensors.

22. The method of claim 21, wherein determining the position of the laser designator in images acquired by the first imaging sensor is performed by line of sight boresighting.

23. The method of claim 21, wherein the first imaging sensor is sensitive to a wavelength of the laser designator so that determining the position of the laser designator in images acquired by the first imaging sensor can be performed by determining the position of a spot corresponding to the laser designator on the images acquired by the first imaging sensor.
